(19) United States
(12) Patent Application Publication
(10) Pub. No.: US 2025/0371831 A1
(43) Pub. Date: Dec. 4, 2025

(54) COLORATION CONTROL FOR VIRTUAL OBJECTS

(71) Applicant: Tencent Technology (Shenzhen) Company Limited, Shenzhen (CN)

(72) Inventor: Xiaoquan HUANG, Shenzhen (CN)

(73) Assignee: Tencent Technology (Shenzhen) Company Limited, Shenzhen (CN)

(21) Appl. No.: 19/296,783

(22) Filed: Aug. 11, 2025

Related U.S. Application Data
(63) Continuation of application No. PCT/CN2024/085165, filed on Apr. 1, 2024.

(30) Foreign Application Priority Data
May 30, 2023 (CN) 202310628581.2

(51) Int. Cl. G06T 19/20; A63F 13/577; A63F 13/60; G06T 13/40

(52) U.S. Cl. CPC G06T 19/20; A63F 13/577; A63F 13/60; G06T 13/40; G06T 2219/2012

(57) ABSTRACT

In a method for controlling display of a virtual object, the virtual object is displayed in a virtual environment. The virtual object has a disguise skill. A user operation is received to activate the disguise skill. A first coloration of the virtual object is changed to a second coloration in response to the user operation. The second coloration is determined based on a coloration in the virtual environment at a location of the virtual object. Apparatus and non-transitory computer-readable storage medium counterpart embodiments are also contemplated.

### RELATED APPLICATIONS

The present application is a continuation of International Application No. PCT/CN2024/085165, filed on Apr. 1, 2024, which claims priority to Chinese Patent Application No. 202310628581.2, filed on May 30, 2023. The entire disclosures of the prior applications are hereby incorporated by reference.

### FIELD OF THE TECHNOLOGY

This application relates to the field of application technologies, including an appearance control method for a virtual object.

### BACKGROUND OF THE DISCLOSURE

In some game applications, a user may attack an enemy virtual object in a manner of controlling a virtual object to shoot, throw a virtual grenade, or throw a virtual bomb in a virtual environment or in another manner.

In a process of controlling a virtual object to participate in a virtual battle, the virtual object may be controlled to walk, and use a tree, a stone, a house, or the like as a cover, to avoid an attack from an enemy virtual object. Particularly, there is a virtual garment that has a color and a pattern the same as those of green grass. The virtual garment can be hidden in the grass after being worn, and cannot be easily identified.

However, the foregoing manner of controlling the virtual object to hide is only effective when the virtual object is hidden in the grass.

### SUMMARY

Aspects of this disclosure provide an appearance control method, an apparatus, and a non-transitory computer-readable storage medium, so that the virtual object can lie in ambush in different virtual environments and is not easy to be discovered. Examples of technical solutions of this disclosure may be implemented as follows:

An aspect of this disclosure provides a method for controlling display of a virtual object. The virtual object is displayed in a virtual environment. The virtual object has a disguise skill. A user operation is received to activate the disguise skill. A first coloration of the virtual object is changed to a second coloration in response to the user operation. The second coloration is determined based on a coloration in the virtual environment at a location of the virtual object.

An aspect of this disclosure provides an apparatus for controlling display of a virtual object. The apparatus includes processing circuitry configured to display the virtual object in a virtual environment. The virtual object has a disguise skill. The processing circuitry is configured to receive a user operation to activate the disguise skill. The processing circuitry is configured to change a first coloration of the virtual object to a second coloration in response to the user operation. The second coloration is determined based on a coloration in the virtual environment at a location of the virtual object.

According to an aspect of this disclosure, an appearance control method for a virtual object is provided. The method is performed by a terminal and includes: displaying a virtual object in a virtual environment, the virtual object having a disguise skill; receiving a skill release operation configured for triggering release of the disguise skill; and replacing a first appearance material of the virtual object with a second appearance material in response to the skill release operation, the second appearance material being determined based on the virtual environment in which the virtual object is located.

According to another aspect of this disclosure, an appearance control apparatus for a virtual object is provided. The apparatus includes: a display module, configured to display a virtual object in a virtual environment, the virtual object having a disguise skill; a receiving module, configured to receive a skill release operation configured for triggering release of the disguise skill; and a processing module, configured to replace a first appearance material of the virtual object with a second appearance material in response to the skill release operation, the second appearance material being determined based on the virtual environment in which the virtual object is located.

According to another aspect of this disclosure, a computer device is provided. The computer device includes a processor and a memory. The memory stores at least one program. The at least one program is loaded and executed by the processor to implement the appearance control method for a virtual object according to various aspects of this disclosure.

An aspect of this disclosure provides a non-transitory computer-readable storage medium, having computer-executable instructions stored therein, the computer-executable instructions, when executed by a processor, cause the processor to implement the appearance control method for a virtual object according to various aspects of this disclosure.

According to another aspect of this disclosure, a computer program product or a computer program is provided. The computer program product or the computer program includes computer instructions. The computer instructions are stored in a computer-readable storage medium. A processor of a computer device reads the computer instructions from the computer-readable storage medium. The processor, when executing the computer instructions, implements the appearance control method for a virtual object according to various aspects of this disclosure.

According to another aspect of this disclosure, a chip is provided. The chip includes a programmable logic circuit and/or program instructions. When run, the chip is configured to implement the appearance control method for a virtual object according to various aspects of this disclosure.

The technical solutions provided in the aspects of this disclosure achieve at least the following beneficial effects.

According to the appearance control method for a virtual object provided in this disclosure, a skill release operation configured for triggering release of a disguise skill is received if a virtual object has the disguise skill, and a first appearance material of the virtual object is replaced with a second appearance material in response to the skill release operation. The second appearance material is determined based on a virtual environment in which the virtual object is located, so that the virtual object with a changed appearance material is integrated with the surrounding virtual environment to hide the virtual object. In this way, the virtual object is not easy to be found, and an enemy virtual object can be deceived, to avoid an attack of the enemy virtual object, or it is easier for the enemy virtual object to successfully ambush the enemy virtual object and achieve an accurate and effective attack on the enemy virtual object.

### BRIEF DESCRIPTION OF THE DRAWINGS

FIG. 1 is a schematic diagram of an interface showing an appearance change of a virtual object according to an aspect of this disclosure.

FIG. 2 is a schematic structural diagram of a computer system according to an aspect of this disclosure.

FIG. 3 is a flowchart of an appearance control method for a virtual object according to an aspect of this disclosure.

FIG. 4 is a schematic diagram of an interface showing an appearance change of a virtual object according to another aspect of this disclosure.

FIG. 5 is a flowchart of an appearance control method for a virtual object according to another aspect of this disclosure.

FIG. 6 is a schematic diagram of a camera model corresponding to a perspective of a virtual object according to an aspect of this disclosure.

FIG. 7 is a schematic diagram of an imaging plane according to an aspect of this disclosure.

FIG. 8 is a schematic diagram of an interface showing an appearance change of a virtual object according to another aspect of this disclosure.

FIG. 9 is a schematic diagram of an interface showing an appearance change of a virtual object according to another aspect of this disclosure.

FIG. 10 is a flowchart of an appearance control method for a virtual object according to an aspect of this disclosure.

FIG. 11 is a flowchart of a release process of a disguise skill according to an aspect of this disclosure.

FIG. 12 is a flowchart of a change process of an appearance material according to an aspect of this disclosure.

FIG. 13 is a flowchart of a release process of a disguise skill according to another aspect of this disclosure.

FIG. 14 is a block diagram of an appearance control apparatus for a virtual object according to an aspect of this disclosure.

FIG. 15 is a schematic diagram of an apparatus structure of a computer device according to an aspect of this disclosure.

### DETAILED DESCRIPTION

First, terms in the aspects of this disclosure are described. The descriptions of the terms are provided as examples only and are not intended to limit the scope of the disclosure.

A virtual environment is a virtual environment displayed (or provided) when an application is run on a terminal. The virtual environment may be a simulated environment of the real world, or may be a semi-simulated and semi-fictional environment, or may be an entirely fictional environment. The virtual environment may be any one of a two-dimensional virtual environment, a 2.5-dimensional virtual environment, and a three-dimensional virtual environment. This is not limited in this disclosure. The following aspects are described by using an example in which the virtual environment is a three-dimensional virtual environment.

A virtual object is a movable object in a virtual environment. The movable object may be a virtual character, a virtual animal, a cartoon character, or the like, for example, a character, an animal, a plant, an oil drum, a wall, or a stone displayed in a three-dimensional virtual environment. In some aspects, the virtual object is a three-dimensional stereoscopic model created based on a skeletal animation technology. Each virtual object has a shape and a volume in the three-dimensional virtual environment, and occupies a part of space in the three-dimensional virtual environment.

A virtual prop is a prop, for example, a virtual vehicle or a virtual instrument, used by a virtual object in a virtual environment to perform some actions. For example, a virtual explosive is a virtual item that can explode in the virtual environment, and is a virtual instrument used by the virtual object in the virtual environment. When the virtual explosive is activated (or explodes), the virtual explosive includes at least one of a grenade, a landmine, a bomb, an atomic bomb, and a missile, and a hit point of the virtual object within an explosive range is reduced. For another example, a shooting virtual prop may be configured to shoot in the virtual environment, and is another virtual instrument used by the virtual object in the virtual environment. When a shooting virtual prop (for example, a bow and arrow) is used to shoot, an enemy virtual object within range is hit, to reduce a hit point of the enemy virtual object. For example, the virtual prop that is “equipped, carried, or assembled” by the virtual object includes a virtual prop that is being used. The virtual object has a virtual inventory, an inventory slot exists in the virtual inventory, and a virtual prop that is not used temporarily may be stored in the virtual inventory of the virtual object. The virtual prop that is “equipped, carried, or assembled” by the virtual object may further include a virtual prop stored in the virtual inventory.

A shooting game is a game in which a virtual object is controlled to battle in a virtual environment by using a virtual instrument. For example, the shooting game includes: a first-person shooting (FPS) game and a third-person shooting (TPS) game. The FPS game is a shooting game that can be played by a user from a first-person perspective. A virtual environment picture in the game is a picture for observing a virtual environment from a perspective of a virtual object. The TPS game is a shooting game that can be played by a user from a third-person perspective. A virtual environment picture in the game is a picture for observing a virtual environment from a perspective for observing a virtual object. Actions of the virtual object can be observed from the third-person perspective.

In the game, at least two virtual objects play a single-round battle in the virtual environment. The virtual object avoids an attack launched by another virtual object and a danger in the virtual environment (for example, a poison circle or a swamp), to survive in the virtual environment. When a hit point of the virtual object in the virtual environment is zero, a life of the virtual object in the virtual environment ends, and a final virtual object surviving in the virtual environment wins. The hit point refers to a life length of the virtual object in the virtual environment. When the hit point of the virtual object is zero, the life of the virtual object in the virtual environment ends. In some aspects, the battle starts with a moment when a first client joins the battle, and ends with a moment when a last client exits the battle. Each client may control one or more virtual objects in the virtual environment. In some aspects, arena modes of the battle may include a single-player battle mode, a two-player team battle mode, or a multiplayer team battle mode. The battle mode is not limited in the aspects of this disclosure.

A control is a user interface (UI) control, that is, any visual control or element that can be seen on a user interface of an application, for example, a control such as a picture, an input box, a text box, a button, or a label. Some UI controls may respond to an operation of the user. For example, after triggering a skill release control of a disguise skill, the user can control a virtual object to change an appearance material, to achieve a disguise effect in a virtual environment.

An appearance control method for a virtual object provided in this disclosure may be applied to a virtual reality (VR) application, an augmented reality (AR) application, an FPS game, a TPS game, a multiplayer online battle arena (MOBA) game, a tactical arena game, a strategy game (SG), or the like. The following aspects are described by using an application in a game as an example.

A game based on a virtual environment includes maps of one or more game worlds. The virtual environment in the game is a simulation of real-world scenes, and a user may control a virtual object in the game to perform actions such as walking, running, jumping, shooting, fighting, driving, switching to a virtual instrument, and attacking another virtual object with the virtual instrument in the virtual environment. This realizes high interactivity, and enables a plurality of users to team up online for a battle arena. The virtual object controlled by the user attacks another virtual object in the virtual environment, for example, an enemy virtual object and a non-player character (NPC). The virtual object controlled by the user may also be attacked by another virtual object in the virtual environment, such as the enemy virtual object and the NPC.

When controlling the virtual object to avoid an attack or to ambush an enemy, the user may control the virtual object to hide. In some games, a virtual garment is provided. The virtual garment has a color and a pattern the same as those of grass. A virtual object wearing the virtual garment is controlled to be hidden in the grass, and is not easy to be identified, but is limited to being hidden in the grass. If the virtual object is in a city, a desert, or a snowfield, the virtual object cannot be hidden.

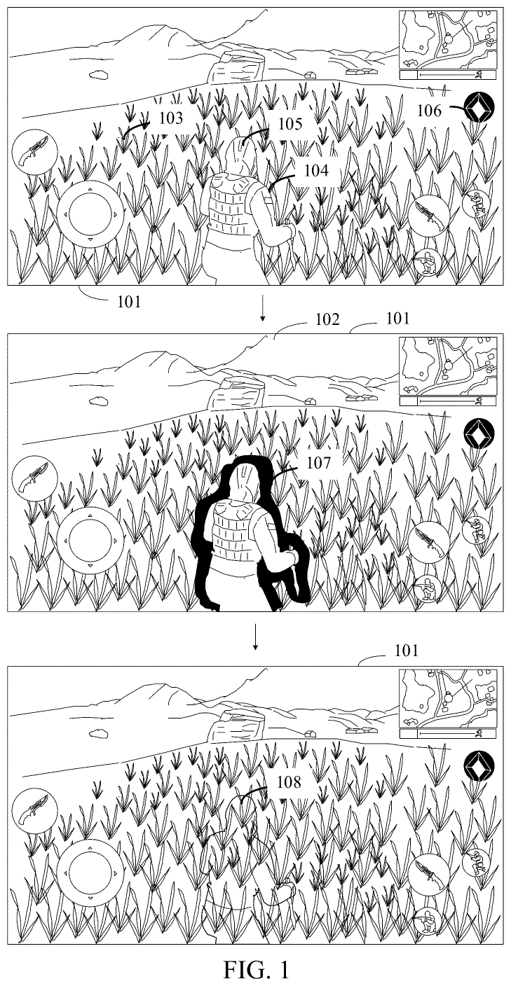

According to the appearance control method for a virtual object provided in this disclosure, an appearance material of a virtual object is replaced based on a virtual environment in which the virtual object is located, so that effective hiding can be achieved regardless of the virtual environment in which the virtual object is located. FIG. 1 is a schematic diagram of an interface showing an appearance change of a virtual object according to an aspect of this disclosure.

A virtual environment picture 102 is displayed on a virtual environment interface 101. The virtual environment picture 102 includes a lawn 103 in a virtual environment. A virtual object 104 stands on the lawn 103. A movement control is further displayed on the virtual environment interface 101. The virtual environment picture 102 is a picture for observing the virtual environment from a perspective of the virtual object 104. A user may trigger the movement control to control the virtual object 104 to move in the virtual environment. When the user controls the virtual object 104 to move in the virtual environment, a perspective for the virtual object 104 to observe the virtual environment changes. The virtual environment interface 101 further includes a perspective adjustment control. The user may further control, by using the perspective adjustment control, the perspective for the virtual object 104 to observe the virtual environment to change.

The virtual object 104 in the virtual environment picture 102 wears a battle garment 105. The virtual environment interface 101 further includes a skill release control 106 of a disguise skill. The user triggers a skill release operation on the skill release control 106. First, a process animation of appearance material replacement for the virtual object 104 is played, as shown in a second interface diagram of FIG. 1. A special effect 107 of appearance material replacement is displayed. Then, a first appearance material of the battle garment 105 is replaced with a second appearance material. The second appearance material has a color and a pattern of grass, as shown in a battle garment 108 of the virtual object in a third interface diagram of FIG. 1, to hide the virtual object 104 in the grass, so as to avoid an attack and ambush an enemy virtual object.

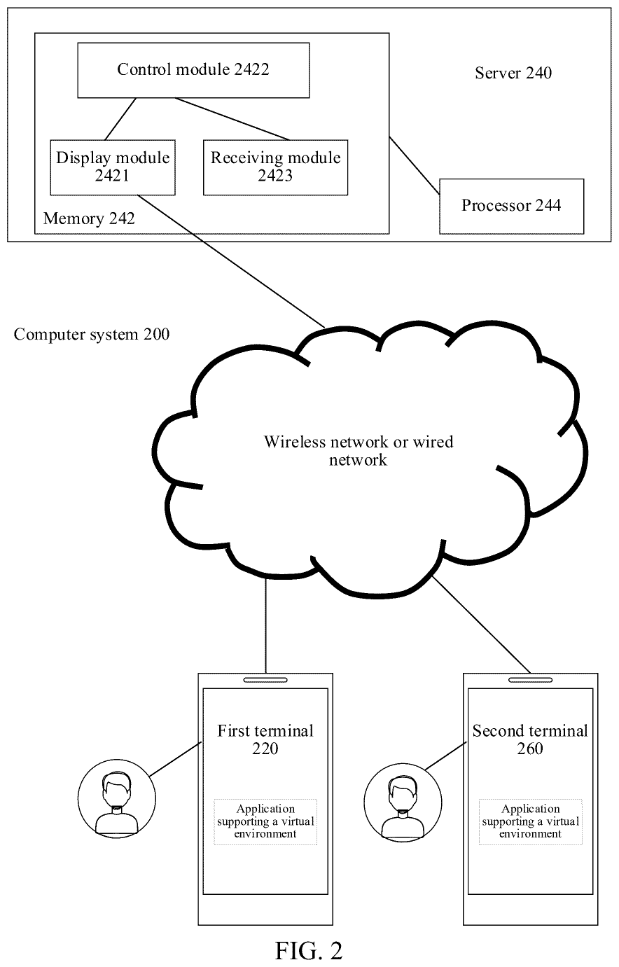

The appearance control method for a virtual object provided in this disclosure may be applied to a computer system. FIG. 2 shows a structural block diagram of a computer system according to an aspect of this disclosure. The computer system 200 includes: a first terminal 220, a server 240, and a second terminal 260.

An application supporting a virtual environment is installed and run on the first terminal 220. The application may be any one of a virtual reality application, an augmented reality application, an FPS game, a TPS game, an MOBA game, and a multiplayer battle survival game. The first terminal 220 is a terminal used by a first user. The first user uses the first terminal 220 to control a first virtual object in the virtual environment to perform an activity. The activity includes, but is not limited to, at least one of body posture adjustment, crawling, walking, running, riding, jumping, driving, shooting, throwing a virtual smoke bomb, and throwing a virtual explosive. For example, the first virtual object is a first virtual character, such as a simulation character or an anime character.

The first terminal 220 is connected to the server 240 through a wireless network or wired network. The server 240 includes at least one of one server, a plurality of servers, a cloud computing platform, and a virtualization center. For example, the server 240 includes a memory 242 and a processor 244. The memory 242 further includes a display module 2421, a control module 2422, and a receiving module 2423. The server 240 is configured to provide a background service for an application that supports a three-dimensional virtual environment. In some aspects, the server 240 takes on primary computing work, and the first terminal 220 and the second terminal 260 takes on secondary computing work; or the server 240 takes on secondary computing work, and the first terminal 220 and the second terminal 260 takes on primary computing work; or collaborative computing is performed by using a distributed computing architecture among the server 240, the first terminal 220, and the second terminal 260.

An application supporting a virtual environment is installed and run on the second terminal 260. The application may be any one of a virtual reality application, an augmented reality application, an FPS game, a TPS game, an MOBA game, and a multiplayer battle survival game. The second terminal 260 is a terminal used by a second user. The second user uses the second terminal 260 to control a second virtual object in the virtual environment to perform an activity. The activity includes, but is not limited to, at least one of body posture adjustment, crawling, walking, running, riding, jumping, driving, shooting, throwing a virtual smoke bomb, and throwing a virtual explosive. For example, the second virtual object is a second virtual character, such as a simulation character or an anime character.

In some aspects, the first virtual object and the second virtual object are in the same virtual environment. In some aspects, the first virtual object and the second virtual object may belong to the same team, or the same organization, or have a friend relationship, or have a temporary communication permission. Alternatively, the first virtual object and the second virtual object may belong to different teams, or different organizations, or have a hostile relationship with each other.

In some aspects, the application installed on the first terminal 220 is the same as the application installed on the second terminal 260, or the applications installed on the two terminals are the same type of applications on different control system platforms. The first terminal 220 may be one of a plurality of terminals, and the second terminal 260 may be one of a plurality of terminals. This aspect is described by only using the first terminal 220 and the second terminal 260 as an example. Device types of the first terminal 220 and the second terminal 260 are the same or different, and the device types include at least one of a smartphone, a tablet computer, a notebook computer, a wearable device, an AR intelligent device, a VR intelligent device, an e-book reader, a moving picture experts group audio layer III (MP3) player, a moving picture experts group audio layer IV (MP4) player, a laptop computer, and a desktop computer. The following aspects are described based on an example in which the terminal includes a smartphone.

A person skilled in the art should understand that a quantity of the above terminals may be larger or smaller. For example, there may be only one terminal, or there are dozens of or hundreds of terminals or more terminals. The quantity and the device types of the terminals are not limited in the aspects of this disclosure.

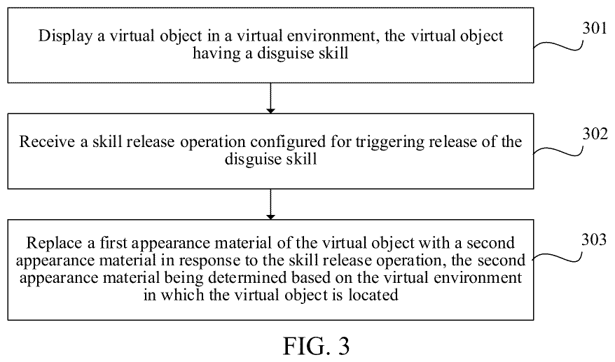

FIG. 3 is a flowchart of an appearance control method for a virtual object according to an aspect of this disclosure. The method may be applied to the terminal of the computer system shown in FIG. 2. The method includes the following operations.

Operation 301: Display a virtual object in a virtual environment, the virtual object having a disguise skill. For example, the virtual object in a virtual environment is displayed. The virtual object has a disguise skill.

An application is run on the terminal. The application supports the virtual environment, and the virtual object exists in the virtual environment. A virtual environment interface is displayed on the terminal, the virtual environment interface includes a virtual environment picture, and the virtual environment picture is a picture obtained by observing the virtual environment from a perspective of the virtual object.

In some aspects, the perspective is an observation angle for observation from a first-person perspective or a third-person perspective of the virtual object in the virtual environment. For example, in this aspect of this disclosure, the perspective is an angle for observing the virtual object through a camera model in the virtual environment. The camera model automatically follows the virtual object in the virtual environment. To be specific, when a position of the virtual object in the virtual environment changes, a position of the camera model following the position of the virtual object in the virtual environment changes simultaneously, and the camera model is always within a preset distance range from the virtual object in the virtual environment. In some aspects, in the automatic following process, relative positions between the camera model and the virtual object remain unchanged.

For example, the virtual environment displayed on the virtual environment picture includes at least one of the following elements: a mountain, a flat land, a river, a lake, an ocean, a desert, the sky, a cloud, the sun, the moon, a star, a plant, an animal, a building, and a vehicle. For example, as shown in FIG. 1, elements such as a lawn, a hill, a stone, and a house are displayed in the virtual environment picture.

In this aspect of this disclosure, the disguise skill is a skill that masks the virtual object in the virtual environment by changing an appearance material of the virtual object to integrate an appearance of the virtual object into the virtual environment in which the virtual object is located. For example, as shown in FIG. 1, after the appearance material of the virtual object is changed, the battle garment 105 of the virtual object is changed to the battle garment 108. When the virtual object is constructed based on a three-dimensional model, a change of the appearance material does not affect the three-dimensional model of the virtual object. For example, a material of the battle garment in FIG. 1 is changed. However, a model of the battle garment is not changed, and a three-dimensional structure of the battle garment in FIG. 1 is not changed.

In some aspects, the disguise skill possessed by the virtual object is a skill possessed by the virtual object. Alternatively, the disguise skill possessed by the virtual object is a skill obtained by using a virtual prop. A manner of obtaining the virtual prop includes, but is not limited to: picking up, purchasing, sharing by another virtual object, and a reward prop obtained by completing a task. Alternatively, the disguise skill possessed by the virtual object is a skill obtained by completing a task. For example, the disguise skill is a reward obtained by controlling the virtual object to complete the task.

The material is a physical property of an object in a simulated virtual environment. For example, the material may include a color, reflection, transparency, and a map. Properties of the material may be collectively referred to as a material ball. For example, properties of the material ball may include, but are not limited to, ambient occlusion (AO), diffusion, a metal property/specular property, glossiness, emission, opacity, a normal, and an environment. The ambient occlusion refers to manually controlling an illumination intensity and distribution of an ambient light source on an object. The diffusion refers to an inherent color of an object, and is a material property that directly represents a color of the object. The specular property is to keep a specular color of an object from being affected by an environment. The metal property is to simulate a specular effect in a real environment based on ambient light. The glossiness refers to a reflection intensity of an object. The emission refers to a luminous intensity of an object. The opacity refers to an object transparency strength. The normal is configured for achieving a bump effect on a plane, to reserve and enrich details. The environment is a secondary operation on a reflection intensity of an object, and mainly deals with a highly reflective material such as a glass mirror. Moreover, the property of the material ball may be a processing switch for a relationship among object illumination, double-sidedness, and transparency, to process a special effect. In some aspects, the appearance material of the virtual object is a material of a garment worn by the virtual object. Alternatively, the appearance material of the virtual object is a surface layer material that can be observed on the virtual object.

Operation 302: Receive a skill release operation configured for triggering release of the disguise skill. For example, a user operation is received to activate the disguise skill.

In some aspects, the skill release operation configured for triggering release of the disguise skill may be a preset gesture operation. For example, in response to triggering a gesture operation on an interactive area of the virtual environment interface, release of the disguise skill is triggered.

In some aspects, the virtual environment interface includes a skill release control of the disguise skill. The terminal receives a skill release operation triggered on the skill release control of the disguise skill. For example, a trigger operation includes, but is not limited to, at least one of the following: a click operation, a double-click operation, a long-press operation, a drag operation, and a slide operation.

As shown in FIG. 1, the skill release control 106 of the disguise skill is displayed on the virtual environment interface, and is configured to trigger release of the disguise skill possessed by the virtual object. In some aspects, if the virtual object has the disguise skill, the skill release control of the disguise skill is displayed on the virtual environment interface. For example, if the virtual object obtains the disguise skill through use of the virtual prop, the skill release control of the disguise skill is displayed on the virtual environment interface.

In some aspects, the skill release control of the disguise skill is located at any position on the virtual environment interface. For example, the skill release control may be located in an edge area of the virtual environment interface. As shown in FIG. 1, the skill release control is located in a right edge area of the virtual environment interface. Alternatively, a position and a layout of the skill release control on the virtual environment interface may be user-defined. For example, the skill release control may be dragged from a first position to a second location, to change the layout and the position of the skill release control.

In some aspects, virtual energy needs to be accumulated for the disguise skill. If the virtual energy accumulated for the disguise skill reaches a preset threshold, skill release of the disguise skill may be triggered. For example, if the virtual energy accumulated for the disguise skill reaches the preset threshold, the skill release control is in a touchable state. If the skill release control is in the touchable state, the terminal may receive the skill release operation triggered on the skill release control. For example, at an initial stage or after one time of skill release is completed, the terminal switches a state of the skill release control from the touchable state to an untouchable state, and after the virtual energy accumulated for the disguise skill reaches the preset threshold, switches the state of the skill release control from the untouchable state to the touchable state. In this case, the terminal may receive the skill release operation on the skill release control.

For example, at the initial stage or after one time of skill release, the accumulated virtual energy reaches the preset threshold after cooling duration, and then the state of the skill release control is switched to the touchable state. For example, after one time of skill release, the skill release control is switched to the untouchable state, and after 30 s of cooling, the state of the skill release control is switched to the touchable state. At the initial stage or after one time of skill release, virtual energy required for release of the disguise skill may be further obtained by executing a task. For example, the virtual energy required for release of the disguise skill is accumulated by picking up and using a virtual energy crystal.

Operation 303: Replace a first appearance material of the virtual object with a second appearance material in response to the skill release operation, the second appearance material being determined based on the virtual environment in which the virtual object is located. For example, a first coloration of the virtual object is changed to a second coloration in response to the user operation. The second coloration is determined based on a coloration in the virtual environment at a location of the virtual object.

In response to the skill release operation, the terminal determines the second appearance material based on the virtual environment in which the virtual object is located, and replaces the first appearance material of the virtual object with the second appearance material. In some aspects, a position of the virtual object in the virtual environment is determined based on the skill release operation. The second appearance material is determined based on an appearance material at the position of the virtual object in the virtual environment. The first appearance material of the virtual object is replaced with the second appearance material.

In some aspects, if the state of the virtual object meets a skill release condition, the terminal performs the operation of replacing a first appearance material of the virtual object with a second appearance material in response to the skill release operation.

For example, the skill release condition includes, but is not limited to, at least one of the following: the virtual object being in a moving state, the virtual object being in a shooting state, the virtual object being in a jumping state, the virtual object being in a sprinting state, the virtual object being in a sliding tackle state, the virtual object being in a squatting state, the virtual object being in a recumbent state, the virtual object being in a static state, and the virtual object being in a skill release area of the disguise skill. The skill release area of the disguise skill may be any area in the virtual environment or a part of an area in the virtual environment.

In some aspects, if the state of the virtual object meets a condition that a skill cannot be released, responding to the skill release operation of the disguise skill is skipped. The condition that a skill cannot be released includes, but is not limited to, at least one of the following: the virtual object being knocked down, the virtual object being climbing, the virtual object being rescuing or being rescued, the virtual object being driving or the virtual object being riding in a virtual vehicle, and the virtual object being in a skill release forbidden area of the disguise skill. The skill release forbidden area of the disguise skill may be a part of the area in the virtual environment.

The skill release condition corresponding to the disguise skill and the condition that a skill cannot be released are preset based on an application requirement.

In some aspects, the terminal switches all appearance materials of the virtual object from the first appearance material to the second appearance material. Alternatively, the terminal switches a part of appearance materials of the virtual object exposed to the virtual environment from the first appearance material to the second appearance material.

Switching of the appearance material may be changing a parameter of the appearance material of the virtual object. The first appearance material corresponds to one group of material parameters, and the second appearance material corresponds to another group of material parameters. The material parameter corresponding to the first appearance material used by the virtual object is changed to the material parameter corresponding to the second appearance material, to replace the appearance material.

In some aspects, in a process in which the terminal controls the first appearance material to be switched to the second appearance material, an instantaneous change manner may be used, that is, the appearance material is directly transitioned from the first appearance material to the second appearance material. Alternatively, a gradual transition manner may be used, that is, the appearance material is gradually transitioned from the first appearance material to the second appearance material.

In some aspects, the terminal first plays an effect animation of appearance material replacement of the virtual object in response to the skill release operation. In a process of playing the effect animation, the terminal gradually switches the first appearance material to the second appearance material, and the playing of the effect animation and the switching of the appearance materials are completed at the same time. Alternatively, after playing the effect animation of appearance material replacement of the virtual object, the terminal directly switches the first appearance material to the second appearance material.

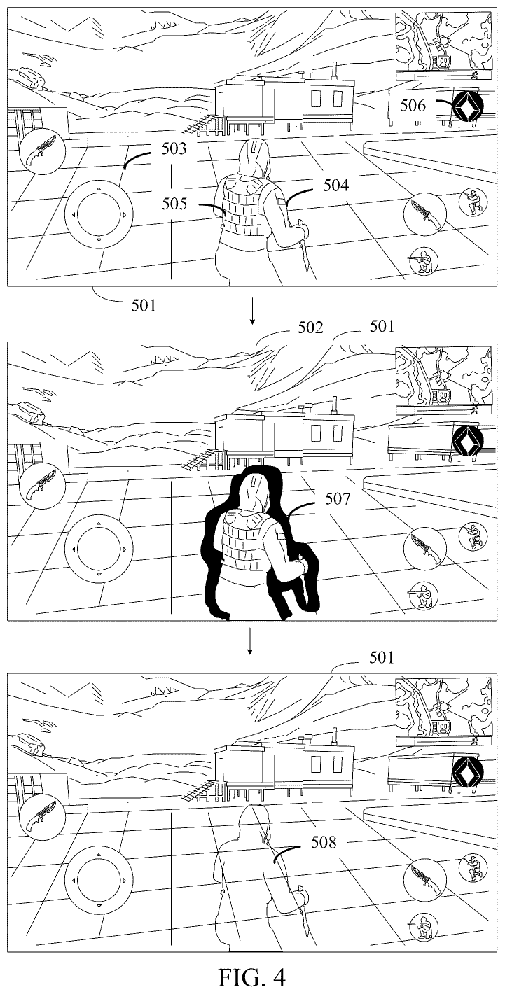

For example, as shown in FIG. 4, a virtual environment picture 502 is displayed on a virtual environment interface 501. The virtual environment picture 502 includes a tile 503 in a virtual environment. A virtual object 504 stands on the tile 503. A movement control is further displayed on the virtual environment interface 501. The virtual environment picture 502 is a picture for observing the virtual environment from a perspective of the virtual object 504. A user may trigger the movement control to control the virtual object 504 to move in the virtual environment. When the user controls the virtual object 504 to move in the virtual environment, a perspective for the virtual object 504 to observe the virtual environment changes. The virtual environment interface 501 further includes a perspective adjustment control. The user may further control, by using the perspective adjustment control, the perspective for the virtual object 504 to observe the virtual environment to change.

The virtual object 504 in the virtual environment picture 502 wears a battle garment 505. The virtual environment interface 501 further includes a skill release control 506 of a disguise skill. The user triggers a skill release operation on the skill release control 506. First, an effect animation of appearance material replacement of the virtual object 504 is played, as shown in a second interface diagram of FIG. 4. A special effect 507 of appearance material replacement is displayed, and then a first appearance material of the battle garment 505 is replaced with a second appearance material. The second appearance material has a color and a pattern of the tile 503, as shown in a battle garment 508 of the virtual object in a third interface diagram of FIG. 4, to hide the virtual object 504 in the grass, so as to avoid an attack and ambush an enemy virtual object.

In some aspects, the foregoing disguise skill is continuously effective, and subsequently, use of the disguise skill may be ended by terminating the skill release operation. Alternatively, a duration threshold is correspondingly set for the foregoing disguise skill, and the duration threshold is configured for indicating effective duration of the disguise skill. The second appearance material of the virtual object is replaced with the first appearance material when the duration reaches the duration threshold. The duration is duration for which the virtual object wears the second appearance material and that starts from a moment at which the virtual object is switched to the second appearance material. For example, the disguise skill can last for 60 seconds(s) after being released, and the virtual object is switched from the second appearance material back to the first appearance material after 60 s.

In some aspects, in a period of time in which the disguise skill is effective, the terminal controls the virtual object to continue to move in the virtual environment, and in a movement process, an appearance material of the virtual object changes as a surrounding virtual environment of the virtual object changes. For example, after replacing the first appearance material of the virtual object with the second appearance material, the terminal controls the virtual object to continue to move in the virtual environment. The terminal re-determines, based on a position to which the virtual object is moved, an appearance material that the virtual object needs to replace, to obtain a third appearance material. The terminal replaces the second appearance material of the virtual object with the third appearance material.

In some aspects, in a period of time in which the disguise skill is effective, with movement of the virtual object in the virtual environment, an appearance material of the virtual object is updated in real time. Alternatively, in a period of time in which the disguise skill is effective, the virtual object is controlled to move from a first position to a second position in the virtual environment. When static duration of the virtual object at the second position reaches a static duration threshold, an appearance material that the virtual object needs to replace is re-determined based on the second position to which the virtual object is moved, to obtain the third appearance material. The second appearance material of the virtual object is replaced with the third appearance material. For determining the third appearance material, refer to a manner of determining the second appearance material. Details are not described herein again.

In some aspects, in a period of time in which the disguise skill is effective, in response to an event of meeting a suspension condition of the disguise skill, the second appearance material of the virtual object is replaced with the first appearance material.

In some aspects, the suspension condition includes, but is not limited to, at least one of the following: the virtual object being hit by the enemy virtual object, a hit point of the virtual object being reduced below a hit point threshold, a spirit point of the virtual object being reduced below a spirit point threshold, the virtual object entering a disguise skill release forbidden area (for example, the virtual object falling into or entering water), and the virtual object performing a first-type action. The first-type action includes, but is not limited to: a climbing action, driving a virtual vehicle, and riding in the virtual vehicle. For example, after the first appearance material of the virtual object is replaced with the second appearance material, when the virtual object is hit by the enemy virtual object, the second appearance material of the virtual object is replaced with the first appearance material. For another example, after the first appearance material of the virtual object is replaced with the second appearance material, when the virtual object is controlled to perform the first-type action, the second appearance material of the virtual object is replaced with the first appearance material.

In some aspects, in a period of time in which the disguise skill is effective, a release effect of a second-type action is further enhanced. The second-type action and the first-type action are actions of different types. For example, when the virtual object is controlled to perform the second-type action, the release effect of the second-type action is enhanced, and the second-type action and the first-type action are actions of different types. For example, the second-type action may be an attack action and/or an action of supplementing virtual energy of the virtual object. For example, in a period of time in which the disguise skill is effective, the virtual object is controlled to shoot, and a damage value and a range of the shooting are increased based on a first preset proportion, for example, increased to 120% of an original damage value and increased to 110% of an original range. For another example, in a period of time in which the disguise skill is effective, the virtual object is controlled to perform an action of supplementing virtual energy, and duration required for supplementing the virtual energy is reduced based on a second preset proportion. For example, 5 s is subtracted from original duration, and/or a virtual energy value of a virtual prop configured to supplement the virtual energy is increased. For example, the virtual energy value of the virtual prop configured to supplement the virtual energy is increased to 110% of an original virtual energy value. For another example, in a period of time in which the disguise skill is effective, the virtual object is controlled to throw a virtual explosive, and a damage range and a damage value of the virtual explosive after activation of the virtual explosive are increased based on a third preset proportion, for example, increased to 120% of an original damage value and increased to 120% of an original damage range.

In some aspects, the virtual object is further equipped with a virtual prop. The first appearance material of the virtual object is replaced with the second appearance material, and a fourth appearance material of the virtual prop is replaced with the first appearance material in response to the skill release operation. For example, in a period of time in which the disguise skill is effective, if the virtual object uses a virtual explosive, the fourth appearance material of the virtual explosive is replaced with the first appearance material. For another example, if the virtual object is equipped with a virtual shooting prop, a fourth appearance material of the virtual shooting prop is replaced with the first appearance material, and an appearance material of a prop generated by shooting is replaced with the first appearance material.

In some aspects, the virtual object is further equipped with a virtual prop. The first appearance material of the virtual object is replaced with the second appearance material, and a fourth appearance material of the virtual prop is replaced with the second appearance material in response to the skill release operation. For example, in a period of time in which the disguise skill is effective, if the virtual object uses a virtual explosive, the fourth appearance material of the virtual explosive is replaced with the second appearance material. In another example, if the virtual object is equipped with a virtual shooting prop, a fourth appearance material of the virtual shooting prop is replaced with the second appearance material, and an appearance material of a prop generated by shooting is replaced with the second appearance material.

In conclusion, according to the appearance control method for a virtual object provided in this aspect, a skill release operation configured for triggering release of a disguise skill is received if a virtual object has the disguise skill, and a first appearance material of the virtual object is replaced with a second appearance material in response to the skill release operation. The second appearance material is determined based on a virtual environment in which the virtual object is located, so that the virtual object with a changed appearance material is integrated with the surrounding virtual environment to hide the virtual object. In this way, the virtual object is not easy to be found, and an enemy virtual object can be deceived, to avoid an attack of the enemy virtual object, or it is easier for the enemy virtual object to successfully ambush the enemy virtual object and achieve an accurate and effective attack on the enemy virtual object.

In addition, in a period of time in which the disguise skill is effective, with movement of the virtual object in the virtual environment, an appearance material of the virtual object is further changed based on a change of the surrounding virtual environment of the virtual object, so that the virtual object can be better hidden in the surrounding virtual environment, to improve a hidden effect of the virtual object in the virtual environment. Further, the disguise skill can further enhance a release effect for some actions, to better ambush enemies in combination with a disguise effect.

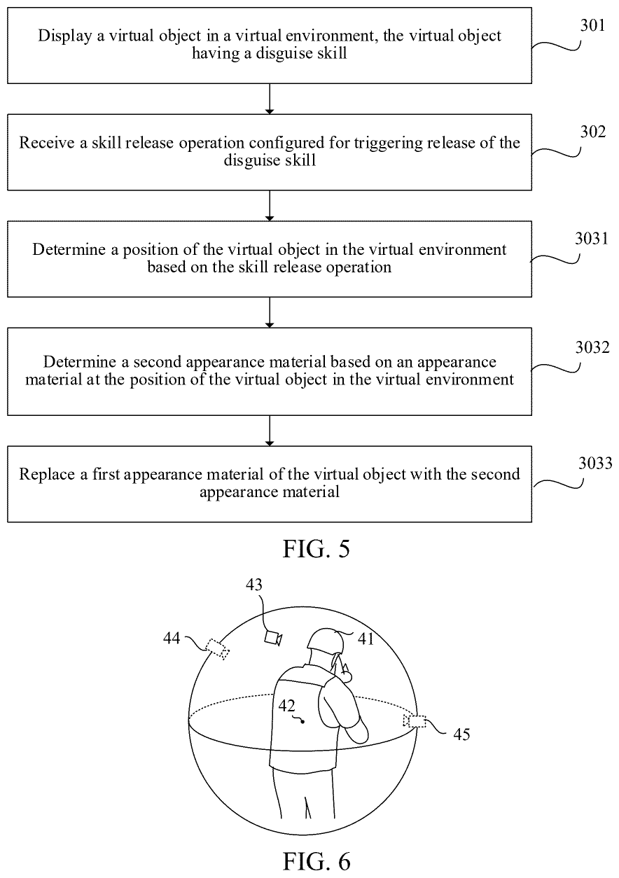

FIG. 5 is a flowchart of an appearance control method for a virtual object according to an aspect of this disclosure. The method may be applied to the terminal of the computer system shown in FIG. 2. As shown in FIG. 5, operation 303 may be implemented through the following operation 3031 to operation 3033, to determine, based on a position of a virtual object in a virtual environment, a second appearance material that is more harmonious with a surrounding virtual environment of the virtual object. The method includes the following operations.

Operation 3031: Determine a position of the virtual object in the virtual environment based on the skill release operation. For example, the location of the virtual object in the virtual environment is determined.

The terminal determines the position of the virtual object in the virtual environment in response to the skill release operation. For example, the position of the virtual object is a position of the virtual object on a virtual map.

Operation 3032: Determine the second appearance material based on an appearance material at the position of the virtual object in the virtual environment. For example, the second coloration is determined based on the coloration of an environmental object in the virtual environment at the location of the virtual object in the virtual environment.

The terminal determines a contact object at the position of the virtual object in the virtual environment, and determines the second appearance material based on an appearance material of the contact object. In some aspects, the terminal determines, in the virtual environment based on the position of the virtual object, a contact object that is in contact with a body part of the virtual object, and determines the second appearance material based on the appearance material of the contact object. For example, the terminal determines three-dimensional space of the virtual object in the virtual environment based on the position of the virtual object. The three-dimensional space of the virtual object is larger than space occupied by a three-dimensional model of the virtual object. In the three-dimensional space of the virtual object, the contact object that is in contact with the body part of the virtual object is determined. The second appearance material is determined based on the appearance material of the contact object. For example, a lawn that is in contact with feet of the virtual object is used as the contact object, and the second appearance material is determined based on an appearance material of the lawn.

In some aspects, the terminal may determine the appearance material of the contact object as the second appearance material. Alternatively, the terminal may determine some parameters of the appearance material of the contact object as parameters of the second appearance material.

In some aspects, there may be one or more objects that are in contact with the virtual object. If the body part of the virtual object is in contact with a plurality of objects in the virtual environment, at least one of the following manners may be used to determine a contact object in the plurality of objects.

(1) The terminal determines a first group of candidate objects based on the position of the virtual object. At least two body parts of the virtual object are in contact with at least two candidate objects in the first group of candidate objects in one-to-one correspondence. The terminal determines a first body part with a highest priority from the at least two body parts based on preset priorities of the body parts. The terminal determines a candidate object corresponding to the first body part in the at least two candidate objects as a contact object. For example, if a back of the virtual object is in contact with a wall, the feet of the virtual object are in contact with the ground, and a priority of the back is higher than a priority of the feet, the wall that is in contact with the back of the virtual object is determined as a contact object.

(2) The terminal determines a first group of candidate objects based on the position of the virtual object. At least two body parts of the virtual object are in contact with at least two candidate objects in the first group of candidate objects in one-to-one correspondence. The terminal calculates a contact area between each candidate object in the first group of candidate objects and a body part corresponding to the virtual object one by one, to obtain at least two contact areas in one-to-one correspondence with the at least two candidate objects. The terminal determines the contact object corresponding to a largest contact area in the at least two contact areas.

In some other aspects, the terminal determines the three-dimensional space of the virtual object in the virtual environment based on the position of the virtual object. The terminal determines the contact object in the three-dimensional space. The terminal determines the second appearance material based on the appearance material of the contact object.

In some aspects, the three-dimensional space includes one or more candidate objects that are in contact with the virtual object. When one candidate object is included in the three-dimensional space, the candidate object is determined as the contact object.

When the three-dimensional space includes the first group of candidate objects, and a plurality of candidate objects in the first group of candidate objects are in contact with the virtual object, an overlapping area of projections of each object in the first group of candidate objects and the virtual object on an imaging plane of the camera model is calculated for the plurality of candidate objects in the three-dimensional space one by one, to obtain at least two overlapping areas in one-to-one correspondence with the at least two candidate objects; and a contact object corresponding to a largest overlapping area in the at least two overlapping areas is determined.

The camera model is a three-dimensional model located around the virtual object in the virtual environment. From a first-person perspective, the camera model is near a head of the virtual object or located at a head of the virtual object. From a third-person perspective, the camera model may be behind the virtual object and bound to the virtual object, or may be located at any position at a preset distance from the virtual object. Through the camera model, the virtual object in the virtual environment may be observed from different perspectives. For example, when the third-person perspective is a first-person over-shoulder perspective, the camera model is behind the virtual object (for example, a head and a shoulder of a virtual character). In addition to the first-person perspective and the third-person perspective, other perspectives are further included, for example, a top-down perspective. From the top-down perspective, the camera model may be located above the head of the virtual object. The top-down perspective is a perspective for observing the virtual environment from the air. The camera model is not actually displayed in the virtual environment. In other words, the camera model is not displayed in a virtual environment displayed on the virtual environment interface. That is, the camera model is not displayed in the virtual environment picture.

An example in which the camera model is located at any position at the preset distance from the virtual object is used for description. One virtual object corresponds to one camera model. The camera model may rotate with the virtual object as a rotation center. For example, the camera model rotates with any point of the virtual object as the rotation center. During rotation, the camera model not only performs angular rotation, but also has a displacement deviation. A distance between the camera model and the rotation center remains unchanged during rotation. In other words, the camera model rotates on a surface of a sphere with the rotation center as a sphere center. Any point of the virtual object may be the head or a torso of the virtual object, or any point around the virtual object. This is not limited in the aspects of this disclosure. In some aspects, when the virtual object is observed through the camera model, a center orientation of the perspective of the camera model is a direction of a point of a sphere surface on which the camera model is located pointing to the sphere center.

In some aspects, the virtual object may alternatively be observed though the camera model at a preset angle in different directions of the virtual object. For example, as shown in FIG. 6, a point is determined in a virtual object 41 as a rotation center 42, a camera model rotates around the rotation center 42, an initial position 43 is configured for the camera model, and the initial position 43 may be a position above and behind the virtual object (for example, a position behind the head). When the camera model rotates to a position 44 or a position 45, a perspective direction of the camera model changes as the camera model rotates.

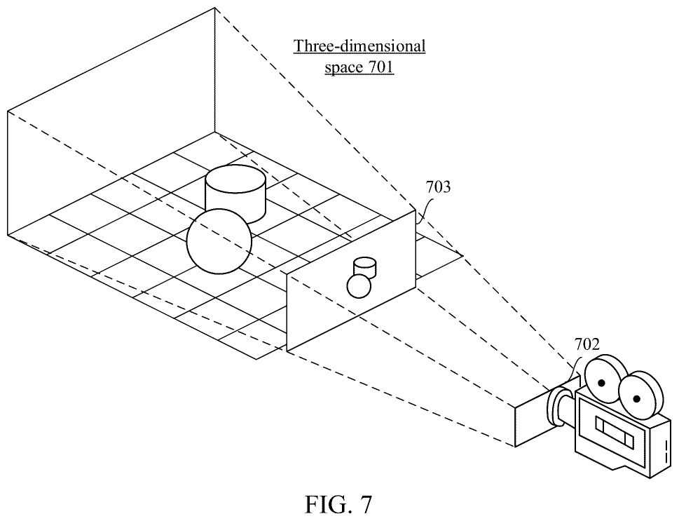

Regarding an imaging plane of the camera model, FIG. 7 is a schematic diagram of a process of mapping an object in three-dimensional space 701 to an imaging plane 703 of the camera model. A camera plane 702 is determined by a pose of the camera model, the camera plane 702 is a plane perpendicular to a photographing direction of the camera model, and the imaging plane 703 and the camera plane 702 are parallel to each other. The imaging plane 703 is a plane of a virtual environment within a field of view during imaging by the camera model when the virtual environment is observed. A sphere represents a virtual object, a cylinder represents an object in contact with a body part of the virtual object, and a coinciding area between spherical imaging and cylindrical imaging on the imaging plane 703 is an overlapping area of projections of the object and the virtual object on the imaging plane of the camera model.

For example, the terminal calculates a coinciding area of imaging of each object and the virtual object on the imaging plane of the camera model, to obtain an overlapping area corresponding to each object.

For example, a size of the three-dimensional space is set based on an application requirement, and the size of the three-dimensional space is greater than a model size of the virtual object. For example, a distance between each position in the three-dimensional space and the virtual object is less than a preset threshold. The preset threshold may be a height of the virtual object, or 1.5 times or 2 times the height of the virtual object.

In some other aspects, the terminal determines a visual cone of the camera model based on the position of the virtual object, the camera model is configured to observe the virtual object in a follow mode, and the visual cone of the camera model includes the virtual object. A first group of candidate objects in the visual cone of the camera model are determined, the first group of candidate objects include at least two candidate objects, and the at least two candidate objects are in contact with the body part of the virtual object. An overlapping area of projections of each object in the first group of candidate objects and the virtual object on the imaging plane of the camera model is calculated one by one, to obtain at least two overlapping areas in one-to-one correspondence with the at least two candidate objects. A contact object corresponding to a largest overlapping area in the at least two overlapping areas is determined. A second appearance material is determined based on an appearance material of the contact object. In some other aspects, the terminal determines at least two candidate objects in a visual cone of the camera model. For each of the at least two candidate objects, the terminal calculates an overlapping area of projections of each candidate object and the virtual object on the imaging plane of the camera model one by one, to obtain at least two overlapping areas in one-to-one correspondence with the at least two candidate objects. The terminal determines a contact object corresponding to a largest overlapping area in the at least two overlapping areas. The terminal determines a second appearance material based on an appearance material of the contact object.

In some other aspects, the terminal determines M objects in a visual cone of the camera model. For each of the M objects, the terminal calculates a vertical distance between the object and a central axis of the visual cone, to obtain M vertical distances corresponding to the M objects. The terminal sorts the M objects from near to far, to obtain M sorted objects. For each of the first R objects in the M sorted objects, the terminal calculates an overlapping area of projections of the object and the virtual object on the imaging plane of the camera model, to obtain R overlapping areas corresponding to the first R objects, where R is an integer greater than 1 and less than or equal to M. The terminal determines a contact object corresponding to a largest overlapping area in the R overlapping areas. The terminal determines a second appearance material based on an appearance material of the contact object. In some other aspects, the terminal determines M objects in a visual cone of the camera model, where M is an integer greater than one. The terminal determines a distance between each of the M objects and the virtual object based on the position of the virtual object. The terminal sorts the M objects from near to far based on the distances from the virtual object, to obtain M sorted objects. For each of the first R objects in the M sorted objects, the terminal calculates an overlapping area of projections of the object and the virtual object on the imaging plane of the camera model, to obtain R overlapping areas corresponding to the first R objects, where R is an integer greater than 1 and less than or equal to M. The terminal determines a contact object corresponding to a largest overlapping area in the R overlapping areas. The terminal determines a second appearance material based on an appearance material of the contact object. In some aspects, the contact object includes at least one of a building, a vehicle, a plant, an animal, and an object in the virtual environment. For example, the contact object may be a wall, a door, a window, a roof, or a column of a house in the virtual environment, or the contact object may be a tree, a flower, a piece of grass, a water bucket, a stone, or a box in the virtual environment.

In some aspects, the contact object includes an object that cannot move in the virtual environment, for example, a house, an object, a plant, a stationary vehicle, a stationary aircraft, a parked ship, or other means of transportation in the virtual environment.

Operation 3033: Replace the first appearance material of the virtual object with the second appearance material. For example, the first coloration of the virtual object is replaced with the second coloration.

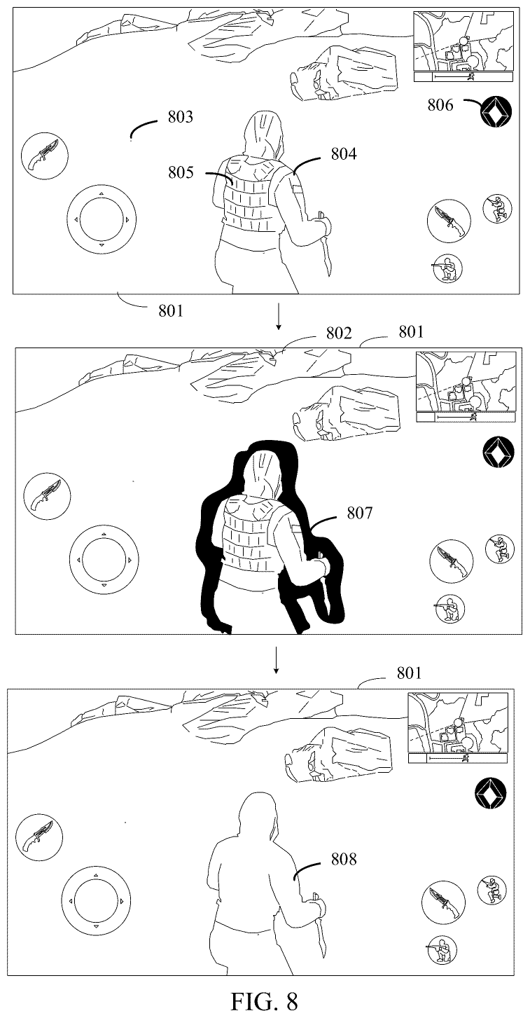

For example, as shown in FIG. 8, a virtual environment picture 802 is displayed on a virtual environment interface 801. The virtual environment picture 802 includes a sand 803 in a virtual environment. A virtual object 804 in the virtual environment picture 802 wears a battle garment 805 and stands on the sand 803, and feet of the virtual object 804 are in contact with the sand 803. The virtual environment interface 801 further includes a skill release control 806 of a disguise skill. A user triggers a skill release operation on the skill release control 806, and determines the sand 803 as a contact object. After an effect animation 807 of replacing an appearance material of the virtual object 804 is played, “as shown in a second interface diagram in FIG. 8”, a first appearance material of the battle garment 805 is replaced with a second appearance material corresponding to the sand 803. As shown in a battle garment 808 of the virtual object in a third interface diagram in FIG. 8, the virtual object 804 is hidden in the sand 803, to avoid an attack and ambush an enemy virtual object.

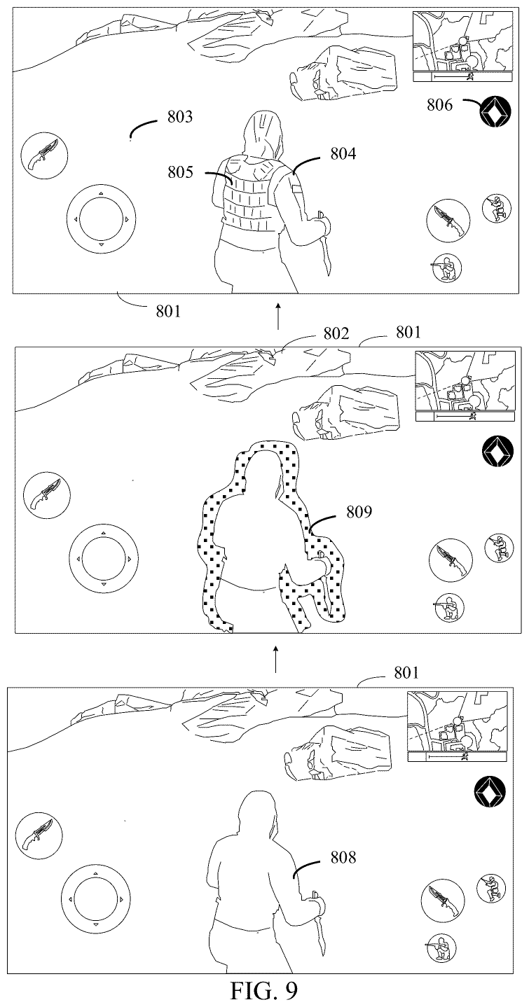

After replacing the first appearance material of the virtual object with the second appearance material, the terminal switches the appearance material of the virtual object back to the first appearance material under a condition. For example, as shown in FIG. 9, in a period of time in which the disguise skill is effective, the virtual object 804 wears the battle garment 808. After the disguise skill is ineffective, an effect animation 809 indicating that the disguise skill is ineffective is played. Then, a second appearance material of the battle garment 808 is replaced with the first appearance material, and the virtual object wearing the battle garment 805 is displayed. The first appearance material is an original appearance material of a virtual garment worn by the virtual object.

In conclusion, according to the appearance control method for a virtual object provided in this aspect, a skill release operation configured for triggering release of a disguise skill is received if a virtual object has the disguise skill, and a first appearance material of the virtual object is replaced with a second appearance material in response to the skill release operation. The second appearance material is determined based on a virtual environment in which the virtual object is located, so that the virtual object with a changed appearance material is integrated with the surrounding virtual environment to hide the virtual object. In this way, the virtual object is not easy to be found, and an enemy virtual object can be deceived, to avoid an attack of the enemy virtual object, or it is easier for the enemy virtual object to successfully ambush the enemy virtual object and achieve an accurate and effective attack on the enemy virtual object. In addition, the contact object in the virtual environment is determined through the contact with the virtual object, so that an appearance of the virtual object after replacement is better integrated with the virtual environment in which the virtual object is located, to achieve a better hiding effect.

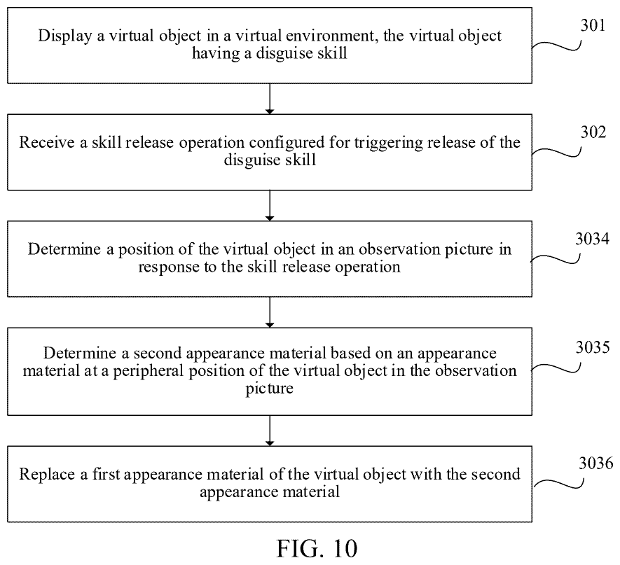

FIG. 10 is a flowchart of an appearance control method for a virtual object according to an aspect of this disclosure. The method may be applied to the terminal of the computer system shown in FIG. 2. As shown in FIG. 5, operation 303 may be implemented through operation 3034 to operation 3036, to determine, in terms of a dimension of observation of the virtual object by an observation object, the second appearance material that is more harmonious with a surrounding virtual environment of the virtual object. The method includes the following operations.

Operation 3034: Determine a position of the virtual object in an observation picture in response to the skill release operation.

In response to the skill release operation, the terminal determines the position of the virtual object in the observation picture. For example, the observation picture is a picture in which the observation object in the virtual environment observes the virtual environment. The observation picture includes the virtual object.

For example, the observation object and the virtual object usually belong to different virtual camps, and the observation object may be referred to as an enemy virtual object of the virtual object. An appearance of the virtual object is masked in the virtual environment through the skill release operation, to prevent the observation object from distinguishing the virtual object in the virtual environment, or increase difficulty in distinguishing the virtual object in the virtual environment by the observation object (for example, consuming longer time or distinguishing the virtual object at a shorter distance).

Operation 3035: Determine the second appearance material based on an appearance material at a peripheral position of the virtual object in the observation picture.

For example, the peripheral position is a position of a pixel adjacent to an edge of the virtual object in the observation picture, or a position in an area whose distance to an edge of the virtual object is less than a preset threshold. For example, similar to the foregoing descriptions, the observation picture is an imaging plane obtained through observation by the camera model, and is a two-dimensional plane obtained through observation of a virtual item, the virtual object, and the like in the virtual environment. The peripheral position of the virtual object belongs to a type of virtual object in the virtual environment. The virtual object to which the peripheral position belongs may be a virtual object such as a virtual sky, or a virtual ground, or a stone, a tree, or a building placed on a virtual ground. This is not limited.

In an implementation, operation 3035 may be implemented as: determining an overlapping object in the observation picture based on the position of the virtual object in the observation picture; and determining the second appearance material based on an appearance material of the overlapping object.

For example, the virtual object blocks the overlapping object in the observation picture. An example in which the virtual environment is observed through the camera model is used. The virtual object is located between the overlapping object and the camera model. This blocks observation of the overlapping object by the camera model.

For example, the overlapping object is usually a virtual object such as a stone, a tree, or a building in the virtual environment, but a case in which the overlapping object is a virtual sky, a virtual ground, or the like is not excluded.

In another example, observation of the virtual environment through the camera model is described. Operation 3035 may be implemented as:
determining a visual cone of the camera model based on a position of the observation object.

The camera model is configured to observe the observation object in a follow mode, and the visual cone of the camera model includes the virtual object. For example, the virtual object can be observed through the camera model of the observation object. To mask the virtual object in the virtual environment, to prevent the observation object from distinguishing the virtual object in the virtual environment, or improve difficulty in distinguishing the virtual object in the virtual environment by the observation object, the second appearance material needs to be determined based on the observation picture. This improves a masking effect of the virtual object in the observation picture.

A second group of candidate objects in the visual cone of the camera model are determined.

The second group of candidate objects include at least two candidate objects, and the virtual object blocks the at least two candidate objects on the imaging plane of the camera model. Refer to the foregoing descriptions. The virtual object is located between the overlapping object and the camera model. This blocks observation of the overlapping object by the camera model.

An overlapping area of projections of each candidate object in the second group of candidate objects and the virtual object on the imaging plane is calculated one by one, to obtain at least two overlapping areas in one-to-one correspondence with the at least two candidate objects. An overlapping object corresponding to a largest overlapping area in the at least two overlapping areas is determined. The second appearance material is determined based on an appearance material of the overlapping object.

Operation 3036: Replace the first appearance material of the virtual object with the second appearance material.

The second appearance material is determined based on the appearance material at the peripheral position of the virtual object in the virtual environment. The first appearance material of the virtual object is replaced with the second appearance material. The second appearance material is replaced, so that in an observation picture of the observation object, an edge of the virtual object and an environment around the virtual object have the same appearance material, to prevent the observation object from distinguishing the virtual object in the virtual environment, or increase difficulty in distinguishing the virtual object in the virtual environment by the observation object.

In conclusion, according to the appearance control method for a virtual object provided in this aspect, a skill release operation configured for triggering release of a disguise skill is received if a virtual object has the disguise skill. A first appearance material of the virtual object is replaced with a second appearance material in response to the skill release operation. The second appearance material is determined based on an appearance material at a peripheral position of the virtual object in an observation picture, so that the virtual object with a changed appearance material is integrated with a surrounding virtual environment in the observation picture to hide the virtual object. In this way, the virtual object is not easy to be found, and an enemy virtual object can be deceived, to achieve a better hiding effect.

As described above, the terminal switches all appearance materials of the virtual object from the first appearance material to the second appearance material. Alternatively, the terminal switches a part of appearance materials of the virtual object exposed to the virtual environment from the first appearance material to the second appearance material.

In an example, the virtual environment interface includes two skill release controls of the disguise skill. All the appearance materials of the virtual object are switched to the second appearance material in response to a trigger operation for a first skill release control. Alternatively, a part of the appearance materials of the virtual object are switched to the second appearance material in response to a trigger operation for a first skill release control. Further, a virtual energy value consumed by the trigger operation for the first skill release control is greater than that consumed by a trigger operation for a second skill release control, or effective duration of a second appearance material corresponding to the first skill release control is shorter than effective duration of a second appearance material corresponding to a second skill release control.

In another example, the virtual environment interface includes a skill release control of the disguise skill. All of the appearance materials of the virtual object are switched to the second appearance material in response to a trigger operation for the skill release control. The skill release control is switched and displayed as a skill conversion control. When there is no trigger operation on the skill conversion control, effective duration of the second appearance material is first duration.

A part of the appearance materials of the virtual object are switched from the second appearance material to the first appearance material, and a part of the appearances of the virtual object are reserved as the second appearance material in response to a trigger operation on the skill conversion control. Effective duration of the reserved second appearance material is second duration, and the second duration is longer than the first duration.

The triggered skill release control is switched and displayed as the skill conversion control, so that a function entrance for performing personalized setting on the disguise skill is provided, and a function entrance for setting a coverage area and effective duration of a second appearance material having a masking effect is provided. In an example, the virtual object prevents the enemy virtual object from distinguishing the position of the virtual object in the virtual environment by triggering the disguise skill. The virtual object launches a virtual attack on the enemy virtual object based on the masking effect, to eliminate the enemy virtual object. After the enemy virtual object is eliminated, there is no other object that constitutes a threat around the virtual object, but a risk that there is another enemy virtual object in an area far away from the virtual object is not excluded. The skill conversion control is triggered, so that a part of the appearance materials of the virtual object are switched from the second appearance material to the first appearance material, and a part of the appearances of the virtual object are reserved as the second appearance material, to reduce the masking effect in the virtual environment, and increase the effective duration of the second appearance material. Requirements for masking a virtual object in different virtual environments can be met.

An example in which the foregoing disguise skill is used in a game is used for description. The disguise skill includes an active skill and a passive skill.
Active skill: After the disguise skill is released, a first appearance material of a virtual object becomes a material (that is, a second appearance material) of an under-foot contact surface of the virtual object, to hide the virtual object in a virtual environment in which the virtual object is located.
Passive skill: An example in which a virtual prop equipped by a virtual object is a virtual shooting prop is used. A shooting velocity and a shooting range of the virtual shooting prop are increased.

A process of releasing the disguise skill is as follows: 1. Virtual energy of the disguise skill already reaches a preset threshold. 2. An action of a virtual object is in a state in which the disguise skill can be released (for example, the disguise skill cannot be released when the virtual object is climbing, wearing a wingsuit, falling down, or riding in a virtual vehicle). 3. The disguise skill is released, and the virtual object may perform actions such as moving, shooting, jumping, sprinting, and sliding tackle in a period of time in which the disguise skill is effective. 4. Effective duration of the disguise skill is T. 5. It is effective for a virtual object that is a releaser.

The disguise skill may be cancelled. A cancellation mechanism is as follows: Automatic cancellation is performed when the virtual object is hit or cut, and a special effect of restoration is played. After the virtual object rides in the virtual vehicle, the disguise skill is automatically cancelled, and the special effect of restoration is played. After the virtual object falls into the water, the disguise skill is automatically cancelled, and the special effect of restoration is played.

A case in which the disguise skill cannot be released includes: The virtual object is in a knock-down state, and the disguise skill cannot be released. The virtual object is in the virtual vehicle, and the disguise skill cannot be released. The virtual object is in a climbing state, and the disguise skill cannot be released. The virtual object is in a rescue state or a rescued state, and the disguise skill cannot be released.

Resources required for appearance material switching include hidden materials (that is, second appearance materials) on various virtual objects, for example, hidden materials in scenes such as a lawn, a stone, and a building; a special effect used during a change of a material when the disguise skill is released; and a special effect of restoring an original appearance material when the disguise skill disappears.

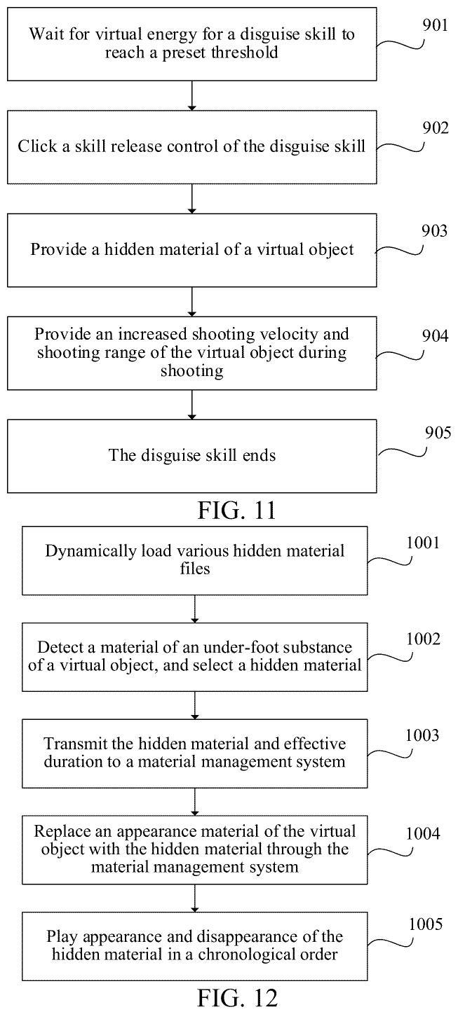

FIG. 11 is a flowchart of a release process of a disguise skill according to an aspect of this disclosure. The method includes the following operations.

Operation 901: Wait for virtual energy of a disguise skill to reach a preset threshold. This process is pre-configured by a planner to determine duration required for the virtual energy to accumulate to reach the preset threshold. A server updates a value and then delivers the value to a client. A virtual energy bar presented as the disguise skill slowly increases, until the virtual energy bar reaches the preset threshold.

Operation 902: Click a skill release control of the disguise skill.

When the virtual energy of the disguise skill reaches the preset threshold, the skill release control of the disguise skill may be clicked, to release the disguise skill.

Operation 903: Provide a hidden material of a virtual object. After the skill is released, the virtual object obtains the hidden material, and an appearance material of the virtual object is changed, to achieve a hiding effect.

Operation 904: Provide an increased shooting velocity and shooting range of the virtual object during shooting.

After the disguise skill is released, a shooting velocity and a shooting range of the virtual object during shooting will be increased. In this way, an attack power of a character is improved, and an enemy virtual object is quickly killed.

Operation 905: The disguise skill ends.

The virtual object is restored to a state before the skill is released, and restored to an original appearance material of the virtual object.

FIG. 12 is a flowchart of a process of replacing an appearance material according to an aspect of this disclosure. The method includes the following operations. Operation 1001: Dynamically load various hidden material files.

A hidden material is an appearance material that is made in advance by art workmates based on an object material in a virtual scene. Loading of these material files is changed to dynamic loading, so that various materials can be conveniently replaced without changing code, and only this file needs to be updated during update.

Operation 1002: Detect a material of an under-foot substance of a virtual object, and select a hidden material.

A spherical ray is extended downward through heels of the virtual object, to determine a collision point. Then, a material of the collision point is determined. The under-foot substance is determined based on the material of the collision point, and then the hidden material for the virtual object is determined based on the under-foot substance.

Operation 1003: Transmit the hidden material and effective duration to a material management system.

The material management system is a system configured to add, search, delete, replace, and present a material. After a disguise skill is triggered, a related material resource identifier and effective duration are used as parameters to be transmitted to the material management system, to implement representation of the hidden material on a character.

Operation 1004: Replace an appearance material of the virtual object with the hidden material through the material management system.

The parameters of the hidden material are transmitted to the material management system, to replace an original appearance material of the virtual object with the hidden material.

Operation 1005: Play appearance and disappearance of the hidden material in a chronological order.

If play time of the hidden material in the material management system does not reach the effective duration, the hidden material is displayed on the virtual object. If the play time of the hidden material reaches the effective duration, the hidden material on the virtual object is restored to a previous original appearance material, for example, a first appearance material.

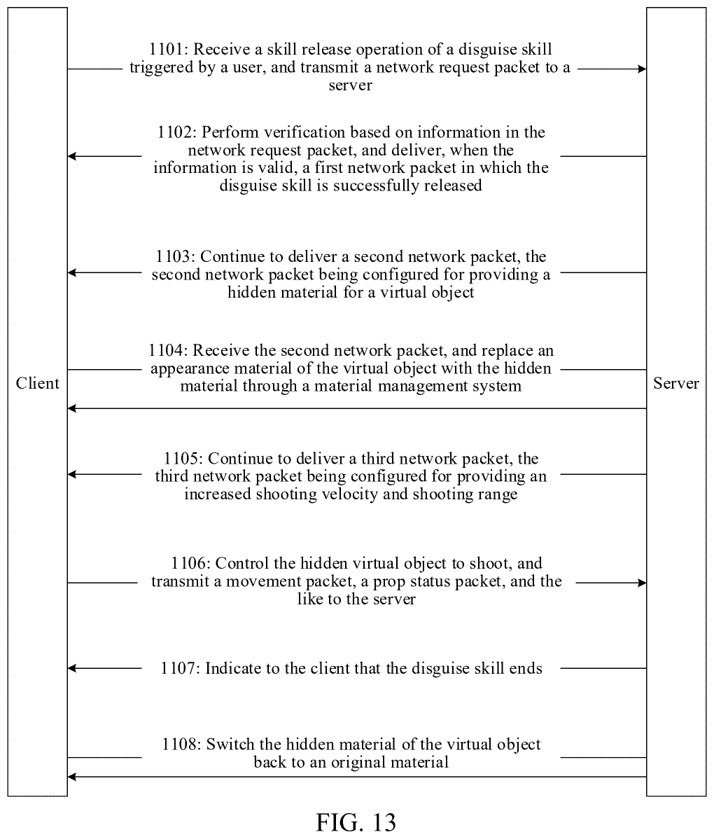

FIG. 13 is a flowchart of a release process of a disguise skill according to an aspect of this disclosure. The method includes the following operations.

Operation 1101: A client receives a skill release operation of a disguise skill triggered by a user, and transmits a network request packet to a server. The network request packet includes user information, information about a virtual object, and information about the disguise skill.

The client is a client of an application that supports a virtual environment and that is run on a terminal.

Operation 1102: The server performs verification based on the information in the network request packet, and delivers, when the information is valid, a first network packet in which the disguise skill is successfully released.

Operation 1103: The server continues to deliver a second network packet, the second network packet being configured for providing a hidden material for a virtual object.

Operation 1104: The client receives the second network packet, and replaces an appearance material of the virtual object with the hidden material through a material management system.

Operation 1105: The server continues to deliver a third network packet, the third network packet being configured for providing an increased shooting velocity and shooting range.

Operation 1106: The client controls the hidden virtual object to shoot, and transmits a movement packet, a prop status packet, and the like to the server.

Operation 1107: The server indicates to the client that the disguise skill ends.

Operation 1108: The client switches the hidden material of the virtual object back to an original material (that is, a first appearance material).

The following describes apparatus aspects of this disclosure. For details not described in the apparatus aspects, refer to corresponding descriptions in the foregoing method aspects. Details are not described in this specification again.

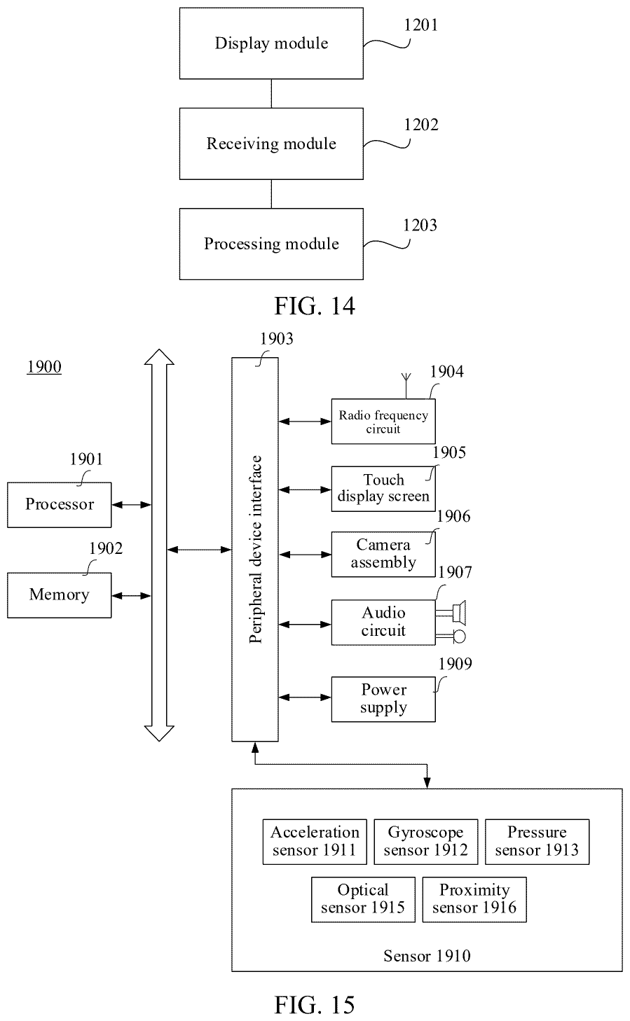

FIG. 14 is a schematic structural diagram of an appearance control apparatus for a virtual object according to an aspect of this disclosure. The apparatus may be implemented as all or a part of a terminal through software, hardware, or a combination of software and hardware. The apparatus includes:
a display module 1201, configured to perform operation 301 in the aspect of FIG. 3;
a receiving module 1202, configured to perform operation 302 in the aspect of FIG. 3; and
a processing module 1203, configured to perform operation 303 in the aspect of FIG. 3.

In some aspects, the processing module 1203 is configured to perform operation 3031 to operation 3033 in the aspect of FIG. 5.

In some aspects, the processing module 1203 is configured to: determine, based on a position of the virtual object, a contact object in contact with a body part of the virtual object in the virtual environment; and
determine a second appearance material based on an appearance material of the contact object.

In some aspects, the processing module 1203 is configured to:
determine a first group of candidate objects based on the position of the virtual object, at least two body parts of the virtual object being in contact with at least two candidate objects in the first group of candidate objects in one-to-one correspondence;
calculate a contact area between each candidate object in the first group of candidate objects and a body part corresponding to the virtual object one by one, to obtain at least two contact areas in one-to-one correspondence with the at least two candidate objects; and
determine the contact object corresponding to a largest contact area in the at least two contact areas.

In some aspects, the processing module 1203 is configured to:
determine, based on the position of the virtual object, a visual cone of a camera model, the camera model being configured to observe the virtual object in a follow mode, and the visual cone of the camera model including the virtual object;
determine a first group of candidate objects in the visual cone of the camera model, the first group of candidate objects including at least two candidate objects, and the at least two candidate objects being in contact with a body part of the virtual object;
calculate an overlapping area of projections of each object in the first group of candidate objects and the virtual object on an imaging plane of the camera model one by one, to obtain at least two overlapping areas in one-to-one correspondence with the at least two candidate objects;
determine a contact object corresponding to a largest overlapping area in the at least two overlapping areas; and
determine the second appearance material based on an appearance material of the contact object.

In some aspects, the processing module 1203 is configured to perform operation 3034 to operation 3036 in the aspect of FIG. 10.

In some aspects, the processing module 1203 is configured to: determine an overlapping object in the observation picture based on the position of the virtual object in the observation picture, the overlapping object being blocked by the virtual object in the observation picture; and determine the second appearance material based on an appearance material of the overlapping object.

In some aspects, the processing module 1203 is configured to:
determine a visual cone of a camera model based on a position of the observation object, the camera model being configured to observe the observation object in a follow mode, and the visual cone of the camera model including the virtual object;
determine a second group of candidate objects in the visual cone of the camera model, the second group of candidate objects including at least two candidate objects, and the at least two candidate objects being blocked by the virtual object on an imaging plane of the camera model;
calculate an overlapping area of projections of each candidate object in the second group of candidate objects and the virtual object on the imaging plane one by one, to obtain at least two overlapping areas in one-to-one correspondence with the at least two candidate objects;
determine an overlapping object corresponding to a largest overlapping area in the at least two overlapping areas; and
determine the second appearance material based on an appearance material of the overlapping object.

In some aspects, the processing module 1203 is configured to: after replacing the first appearance material of the virtual object with the second appearance material, control the virtual object to continue to move in the virtual environment; and re-determine, based on a position to which the virtual object is moved, an appearance material that the virtual object needs to replace, to obtain a third appearance material; and
replace the second appearance material of the virtual object with the third appearance material.

In some aspects, the processing module 1203 is configured to: before replacing the first appearance material of the virtual object with the second appearance material, play an effect animation of appearance material replacement of the virtual object.

In some aspects, the processing module 1203 is configured to: after replacing the first appearance material of the virtual object with the second appearance material, replace the second appearance material of the virtual object with the first appearance material when duration reaches a duration threshold, the duration being duration for which the virtual object wears the second appearance material and that starts from a moment at which the virtual object is replaced with the second appearance material.

In some aspects, the processing module 1203 is configured to: after replacing the first appearance material of the virtual object with the second appearance material, replace the second appearance material of the virtual object with the first appearance material when the virtual object is hit by an enemy virtual object.

In some aspects, the processing module 1203 is configured to: after replacing the first appearance material of the virtual object with the second appearance material, replace the second appearance material of the virtual object with the first appearance material when the virtual object is controlled to perform a first-type action.

Alternatively, the processing module 1203 is configured to: after replacing the first appearance material of the virtual object with the second appearance material, enhance a release effect of a second-type action when the virtual object is controlled to perform the second-type action, the second-type action and the first-type action being different types of actions.

In some aspects, the virtual object is equipped with a virtual prop.

The processing module 1203 is configured to replace a fourth appearance material of the virtual prop with the first appearance material.

In some aspects, the processing module 1203 is configured to: perform, if a state of the virtual object meets a skill release condition, the operation of replacing a first appearance material of the virtual object with a second appearance material in response to the skill release operation.

In some aspects, the processing module 1203 is configured to: skip responding to the skill release operation if a state of the virtual object meets a condition that a skill cannot be released, the condition that a skill cannot be released including at least one of the following: the virtual object being knocked down, the virtual object being climbing, the virtual object being rescuing or being rescued, the virtual object being driving, or the virtual object being riding in a virtual vehicle.

FIG. 15 is a structural block diagram of a computer device 1900 according to an aspect of this disclosure. The computer device 1900 may be a portable mobile terminal, for example, a smartphone, a tablet computer, a moving picture experts group audio layer III (MP3) player, or a moving picture experts group audio layer IV (MP4) player. The computer device 1900 may also be referred to as user equipment, a portable terminal, or other names.

The computer device 1900 includes a processor 1901 and a memory 1902. The processor 1901 may include one or more processing cores, for example, a 4-core processor or an 8-core processor. The processor 1901 may be implemented by at least one hardware form in a digital signal processor (DSP), a field programmable gate array (FPGA), and a programmable logic array (PLA). The processor 1901 may alternatively include a main processor and a coprocessor. The main processor is a processor configured to process data in a wake-up state, and is also referred to as a central processing unit (CPU). The coprocessor is a low power processor configured to process data in a standby state. In some aspects, the processor 1901 may have a graphics processing unit (GPU) integrated therein. The GPU is configured to render and draw content that needs to be displayed on a display. In some aspects, the processor 1901 may further include an artificial intelligence (AI) processor. The AI processor is configured to process a computing operation related to machine learning.

The memory 1902 may include one or more computer-readable storage media. The computer-readable storage media may be visible and non-transient. The memory 1902 may further include a high-speed random access memory and a non-volatile memory, for example, one or more disk storage devices and flash storage devices. In some aspects, the non-transient computer-readable storage medium in the memory 1902 is configured to store at least one instruction. The at least one instruction is executed by the processor 1901 to perform the appearance control method for a virtual object provided in this disclosure.

In some aspects, the computer device 1900 may further include: a peripheral device interface 1903 and at least one peripheral device. For example, the peripheral device includes at least one of a radio frequency (RF) circuit 1904, a touch display screen 1905, a camera assembly 1906, an audio circuit 1907, and a power supply 1909.

The peripheral device interface 1903 may be configured to connect at least one peripheral device related to input/output (I/O) to the processor 1901 (e.g., processing circuitry) and the memory 1902 (e.g., a non-transitory computer-readable storage medium). In some aspects, the processor 1901, the memory 1902, and the peripheral device interface 1903 are integrated on the same chip or circuit board. In some other aspects, any one or two of the processor 1901, the memory 1902, and the peripheral device interface 1903 may be implemented on a single chip or circuit board. This is not limited in this aspect.

The radio frequency circuit 1904 is configured to receive and transmit a radio frequency (RF) signal, also referred to as an electromagnetic signal. The radio frequency circuit 1904 communicates with a communication network and another communication device by using the electromagnetic signal. The touch display screen 1905 is configured to display a user interface (UI). The UI may include a graph, a text, an icon, a video, or any combination thereof. The camera assembly 1906 is configured to capture an image or a video. In some aspects, the camera assembly 1906 includes a front-facing camera and a rear-facing camera. The audio circuit 1907 is configured to provide an audio interface between a user and the computer device 1900. The audio circuit 1907 may include a microphone and a speaker. The microphone is configured to acquire sound waves of a user and an environment, and convert the sound waves into an electrical signal to input to the processor 1901 for processing, or input to the radio frequency circuit 1904 for implementing voice communication. The power supply 1909 is configured to supply power to components in the computer device 1900. The power supply 1909 may be an alternating current power supply, a direct current power supply, a disposable battery, or a rechargeable battery. When the power supply 1909 includes a rechargeable battery, the rechargeable battery may be a wired rechargeable battery or a wireless rechargeable battery.

In some aspects, the computer device 1900 further includes one or more sensors 1910. The one or more sensors 1910 include, but are not limited to, an acceleration sensor 1911, a gyroscope sensor 1912, a pressure sensor 1913, an optical sensor 1915, and a proximity sensor 1916. The acceleration sensor 1911 may detect a magnitude of acceleration on three coordinate axes of a coordinate system established with the computer device 1900. The gyroscope sensor 1912 may detect a body direction and a rotation angle of the computer device 1900. The gyroscope sensor 1912 may cooperate with the acceleration sensor 1911 to acquire a 3D action by the user on the computer device 1900. The pressure sensor 1913 may be disposed at a side frame of the computer device 1900 and/or a lower layer of the touch display screen 1905. The pressure sensor detects a signal of holding the computer device 1900 by the user, and/or controls an operable control on the UI based on a pressure operation of the user on the touch display screen 1905. The optical sensor 1915 is configured to acquire an ambient light intensity. The proximity sensor 1916, also referred to as a distance sensor, is disposed on a front surface of the computer device 1900. The proximity sensor 1916 is configured to acquire a distance between the user and the front surface of the computer device 1900.

A person skilled in the art should understand that, the structure shown in FIG. 15 does not constitute a limitation on the computer device 1900, and may include more or fewer components than these shown in the figure, or combine some components, or use different component arrangements.

This disclosure further provides a computer device. The computer device includes a processor and a memory. The memory stores at least one program. The at least one program is loaded and executed by the processor to implement the appearance control method for a virtual object provided in the foregoing method aspects.

This disclosure further provides a computer-readable storage medium such as a non-transitory computer-readable storage medium. The storage medium stores at least one program. The at least one program is loaded and executed by a processor to implement the appearance control method for a virtual object provided in the foregoing method aspects.

This disclosure further provides a computer program product. When the computer program product runs on a computer, the computer is enabled to perform the appearance control method for a virtual object provided in the foregoing method aspects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A method for controlling display of a virtual object, the method comprising:
displaying the virtual object in a virtual environment, the virtual object having a disguise skill;
receiving a user operation to activate the disguise skill; and
changing, by processing circuitry, a first coloration of the virtual object to a second coloration in response to the user operation, the second coloration being determined based on a coloration in the virtual environment at a location of the virtual object.

2. The method according to claim 1, wherein the changing comprises:
determining the location of the virtual object in the virtual environment;
determining the second coloration based on the coloration of an environmental object in the virtual environment at the location of the virtual object in the virtual environment; and
replacing the first coloration of the virtual object with the second coloration.

3. The method according to claim 2, wherein the determining the second coloration comprises:
determining the environmental object in the virtual environment based on the location of the virtual object, the environmental object being in contact with the virtual object; and
determining the second coloration based on the coloration of the environmental object.

4. The method according to claim 3, wherein the determining the environmental object comprises:
determining a first group of candidate objects based on the location of the virtual object, each candidate object of the first group contacting the virtual object;
calculating, for each candidate object in the first group, a contact area between the candidate object and the virtual object; and
determining a candidate object from the first group of candidate objects with a largest contact area as the environmental object.

5. The method according to claim 2, wherein the determining the second coloration comprises:
determining a view frustum of a virtual camera for viewing the virtual object;
determining a first group of candidate objects in the view frustum, each candidate object of the first group contacting the virtual object;
calculating, for each candidate object in the first group, an overlapping area between projections of the respective candidate object and the virtual object on an imaging plane of the virtual camera;
determining, as an environmental object, a candidate object from the first group of candidate objects with a largest overlapping area; and
determining the second coloration based on a coloration of the environmental object.

6. The method according to claim 1, wherein the changing comprises:
determining a location of the virtual object in an observation picture in response to the user operation, the observation picture being generated from a view perspective of an observing virtual object in the virtual environment; and
determining the second coloration based on a coloration of the virtual environment at the location of the virtual object in the observation picture.

7. The method according to claim 6, wherein the determining the second coloration comprises:
determining an overlapping object in the observation picture based on the location of the virtual object in the observation picture, the overlapping object being partially blocked by the virtual object in the observation picture; and
determining the second coloration based on a coloration of the overlapping object.

8. The method according to claim 6, wherein the determining the second coloration comprises:
determining a view frustum of a virtual camera for viewing the observing virtual object;
determining a plurality of candidate objects in the view frustum that are at least partially blocked by the virtual object on an imaging plane of the virtual camera;
calculating, for each candidate object, an overlapping area between projections of the respective candidate object and the virtual object on the imaging plane of the virtual camera;
determining, as an overlapping object, the candidate object with a largest overlapping area; and
determining the second coloration based on a coloration of the overlapping object.

9. The method according to claim 1, further comprising:
controlling the virtual object to move in the virtual environment;
determining a third coloration based on a location to which the virtual object moves; and
changing the second coloration of the virtual object with the third coloration.

10. The method according to claim 1, further comprising:
displaying a transition animation when a coloration of the virtual object changes.

11. The method according to claim 1, further comprising:
changing the second coloration to the first coloration when an activation duration of the disguise skill reaches a duration threshold.

12. The method according to claim 1, further comprising:
changing the second coloration of the virtual object to the first coloration when another virtual object attacks the virtual object.

13. The method according to claim 1, further comprising:
deactivating the disguise skill when the virtual object performs a first-type action; or
enhancing an effect of a second-type action when the virtual object performs the second-type action while the disguise skill is activated.

14. The method according to claim 1, wherein
the virtual object is equipped with a virtual prop; and the method further includes changing a coloration of the virtual prop to the second coloration.

15. The method according to claim 1, wherein the changing comprises:
determining whether a state of the virtual object meets a skill release condition; and
changing the first coloration of the virtual object to the second coloration when the state of the virtual object meets the skill release condition.

16. The method according to claim 1, further comprising:
determining whether a state of the virtual object meets a skill inhibit condition; and
when the state meets the skill inhibit condition, skipping execution of the disguise skill,
wherein the skill inhibit condition includes at least one of: the virtual object being knocked down, the virtual object climbing, the virtual object rescuing or being rescued, the virtual object driving, or the virtual object riding in a virtual vehicle.

17. An apparatus for controlling display of a virtual object, the apparatus comprising
processing circuitry configured to:
display the virtual object in a virtual environment, the virtual object having a disguise skill;
receive a user operation to activate the disguise skill; and
change a first coloration of the virtual object to a second coloration in response to the user operation, the second coloration being determined based on a coloration in the virtual environment at a location of the virtual object.

18. The apparatus according to claim 17, wherein the processing circuitry is configured to:
determine the location of the virtual object in the virtual environment;
determine the second coloration based on the coloration of an environmental object in the virtual environment at the location of the virtual object in the virtual environment; and
replace the first coloration of the virtual object with the second coloration.

19. The apparatus according to claim 18, wherein the processing circuitry is configured to:
determine the environmental object in the virtual environment based on the location of the virtual object, the environmental object being in contact with the virtual object; and
determine the second coloration based on the coloration of the environmental object.

20. A non-transitory computer-readable storage medium storing instructions which, when executed by a processor, cause the processor to perform:
displaying a virtual object in a virtual environment, the virtual object having a disguise skill;
receiving a user operation to activate the disguise skill; and
changing a first coloration of the virtual object to a second coloration in response to the user operation, the second coloration being determined based on a coloration in the virtual environment at a location of the virtual object.
